(19) United States
(12) Patent Application Publication
(10) Pub. No.: US 2026/0301185 A1
(43) Pub. Date: Oct. 1, 2026

(54) X-RAY CT APPARATUS, MEDICAL IMAGE SEGMENTATION APPARATUS AND METHOD

(71) Applicant: CANON MEDICAL SYSTEMS CORPORATION, Otawara-shi (JP)

(72) Inventors: Sonia DAHDOUH, Edinburgh (GB); Christopher BOLAND, Edinburgh (GB); Angel Victor JUANCO-MULLER, Edinburgh (GB)

(73) Assignee: CANON MEDICAL SYSTEMS CORPORATION, Otawara-shi (JP)

(21) Appl. No.: 19/093,494

(22) Filed: Mar. 28, 2025

(51) Int. Cl. G06T 7/11; G06V 10/26; G06V 10/774; G06V 10/776; G06V 10/82

(52) U.S. Cl. CPC G06T 7/11; G06V 10/26; G06V 10/774; G06V 10/776; G06V 10/82; G06T 2207/10081; G06T 2207/20081; G06T 2207/20084; G06T 2207/30004; G06V 2201/03

(57) ABSTRACT

An X-ray CT apparatus for training machine learning model to segment medical images, the X-ray CT apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical feature of interest in the medical image data set by reducing at least one loss that is based at least in part on the shape priors.

### FIELD

Embodiments described herein relate generally to X-ray CT apparatus, medical image segmentation apparatus and method for processing medical imaging data, for example for training and using a model to provide segmentation for medical imaging data.

### BACKGROUND

While human expert annotation on medical images is guided by an accurate knowledge of human anatomy and the considered structures, use of deep-learning based models can lead to segmentation failures.

In clinical routines, images can present numerous artefacts, tissue distortions or pathologies that can change the normal appearance of part of the tissues, which impacts automated segmentation performance for deep neural networks. While numerical results may show good or acceptable segmentation performance, the resulting segmented tissue shape on these images can differ significantly from the ground truth. This can impair any shape-based or fine textural analysis that may be performed on the results of the segmentation.

Shape priors have been used with neural networks. In some instances, a discriminator has been used to determine if a shape generated by a segmentor is fake or not by employing an adversarial approach. However, while this may guide the segmentor towards a realistic shape it does not provide any guarantees regarding the accuracy of the shape for a specific patient. In other instances a unique shape prior computed offline has been used to condition segmentation. However, since only a single shape prior is used for all patients, no adaptation to the local anatomy or pathology is possible and this limits segmentation performance. In another example an auto-encoder has been used to learn a shape space in the form of a non-linear low dimensional manifold. A shape regularization term for the segmentor is then computed by projecting both predicted shapes and ground truth shapes onto the shape encoder latent space and calculating the Euclidean distance between both latent space representations. While this regularization enforces global shape consistency in model predictions it fails to take into account local variations. A conditional discriminator has been used to enforce realism of predicted shapes. Auto-encoders have also been used to encode shapes, for example in relation to in pattern recognition.

### BRIEF DESCRIPTION OF THE DRAWINGS

Embodiments are now described, by way of non-limiting example, and are illustrated in the following figures, in which:

FIG. 1 is a schematic diagram of an X-ray CT apparatus according to an embodiment;

FIG. 2 is a schematic diagram of an apparatus according to an embodiment;

FIG. 3 is a schematic of a method for training a machine learning model according to an embodiment;

FIG. 4 is a schematic of a method for training a machine learning model according to an embodiment;

FIG. 5 is a schematic of a method for training a machine learning model according to an embodiment; and

FIG. 6 is a schematic of a method for segmenting images according to an embodiment.

### DETAILED DESCRIPTION

According to certain embodiments there is provided an X-ray CT apparatus for training a machine learning model to segment medical images, the X-ray CT apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical feature of interest in the medical image data set by reducing at least one loss that is based at least in part on the shape priors.

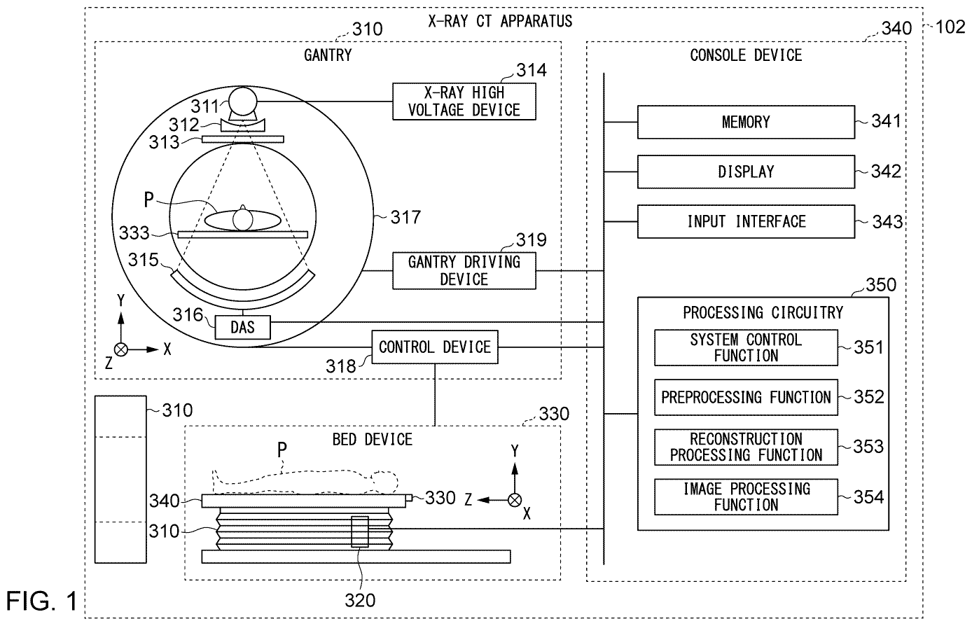

An X-ray CT apparatus 102 according to an embodiment is illustrated schematically in FIG. 1. The X-ray CT apparatus 102 includes, for example, a gantry 310, a bed device 330, and a console device 340. Although FIG. 1 shows both a view of the gantry 310 viewed in the Z-axis direction and a view of the gantry 310 viewed in the X-axis direction for convenience of description, in reality there is only one gantry 310 in this embodiment. In the embodiment, a rotation axis of a rotating frame 317 in a non-tilted state or the longitudinal direction of a top plate 333 of the bed device 330 is defined as the Z-axis direction, and the axis perpendicular to the Z-axis direction and horizontal to the floor surface is defined as the X-axis direction, and the direction perpendicular to the Z-axis direction and orthogonal to the floor surface is defined as the Y-axis direction.

The bed device 330 is a device that moves the to-be-scanned subject P placed thereon to introduce the patient P into the rotating frame 317 of the gantry 310. The bed device 330 includes, for example, a base 331, a bed driving device 332, a top plate 333, and a support frame 334.

The gantry 310 includes, for example, an X-ray tube 311, a wedge 312, a collimator 313, an X-ray high voltage device 314, an X-ray detector 315, and a data acquisition system (hereinafter, DAS) 316, the rotating frame 317, a control device 318, and a gantry driving device 319. The X-ray tube 311, the wedge 312, the collimator 313, the X-ray high voltage device 314, the X-ray detector 315, the DAS 316, the rotating frame 317, and the control device 318 are housed in a housing. The housing is provided with input interfaces such as switches that are operated by an operator. The rotating frame 317 rotatably holds the X-ray tube 311, the wedge 312, the collimator 313, and the X-ray detector 315. The rotating frame 317 may hold the X-ray detector 315, the DAS 316, and the control device 318.

The X-ray tube 311 generates X-rays by radiating thermoelectrons from the cathode (filament) toward the anode (target) when a high voltage from the X-ray high voltage device 314 is applied thereto. The X-ray tube 311 includes a vacuum tube. For example, the X-ray tube 311 is a rotating anode type X-ray tube that generates X-rays by radiating thermoelectrons to a rotating anode.

The wedge 312 is a filter for adjusting the X-ray dose radiated from the X-ray tube 311 to a subject P. The wedge 312 attenuates the X-rays that pass through the wedge 312 such that the distribution of the X-ray dose radiated from the X-ray tube 311 to the subject P becomes a predetermined distribution. The wedge 312 is, for example, made of aluminum processed to have a predetermined target angle and a predetermined thickness.

The collimator 313 is a mechanism for narrowing down the radiation range of X-rays that have passed through the wedge 312. The collimator 313 narrows down the radiation range of X-rays by forming a slit using a combination of a plurality of lead plates, for example. The collimator 313 may be called an X-ray diaphragm. The narrowing range of the collimator 313 may be mechanically drivable.

The X-ray high voltage device 314 includes, for example, a high voltage generator that is not shown and an X-ray control device that is not shown. The high voltage generator has an electric circuit including a transformer, a rectifier, and the like, and generates a high voltage to be applied to the X-ray tube 311. The X-ray control device controls an output voltage of the high voltage generator depending on the X-ray dose to be generated in the X-ray tube 311.

The X-ray detector 315 detects the intensity of X-rays generated by the X-ray tube 311 and incident thereon after having passed through the subject P. The X-ray detector 315 outputs an electrical signal (may output an optical signal or the like) corresponding to the detected intensity of X-rays to the DAS 316.

The DAS 316 collects count data indicating the number of counts of X-ray photons detected by the X-ray detector 315. The DAS 316 outputs detection data based on digital signals to control device 318.

The control device 318 includes, for example, processing circuitry having a processor such as a CPU. The control device 318 receives an input signal from an input interface attached to the gantry 310 or the console device 340 and controls the operations of the gantry 310, the bed device 330, and the DAS 316. For example, the control device 318 controls the gantry driving device 319 to rotate the rotating frame 317 or tilt the gantry 310.

The processing circuitry 350 controls the overall operation of the X-ray CT apparatus 102, the operation of the gantry 310, the operation of the bed device 330, and a calibration operation for collecting correction data. The processing circuitry 350 includes, for example, a system control function 351, a preprocessing function 352, a reconstruction function 353, an image processing function 354, and the like.

These components are realized, for example, by a hardware processor (computer) executing a program (software) stored in the memory 341. The hardware processor is, for example, circuitry such as a CPU, a graphics processing unit (GPU), an application specific integrated circuit (ASIC), or a programmable logic device (for example, a simple programmable logic device (SPLD), a complex programmable logic device (CPLD), or a field programmable gate array (FPGA). The program may be directly incorporated into the circuitry of the hardware processor instead of being stored in the memory 341.

In this case, the hardware processor realizes the functions by reading and executing the program incorporated into the circuitry. The hardware processor is not limited to being configured as a single circuit and may be configured as one hardware processor by combining a plurality of independent circuits to realize each function. Further, a plurality of components may be integrated into one hardware processor to realize each function.

The respective components included in the console device 340 or the processing circuitry 350 may be distributed and realized by a plurality of pieces of hardware. The processing circuitry 350 may be realized by a processing device that can communicate with the console device 340 instead of being a component included in the console device 340. The processing device is, for example, a workstation connected to one X-ray CT apparatus, or a device (e.g., a cloud server) that is connected to a plurality of X-ray CT apparatuses and collectively executes the same processing as that of the processing circuitry 350 which will be described below.

The system control function 351 controls various functions of the processing circuitry 350 on the basis of input operations received by the input interface 343.

The preprocessing function 352 performs preprocessing such as logarithmic conversion processing, offset correction processing, inter-channel sensitivity correction processing, beam hardening correction, scattered radiation correction, and dark count correction on detection data output by the DAS 316 to generate projection data. The projection data includes count data.

The reconstruction function 353 reconstructs a photon counting type CT image of the subject P on the basis of detection data (count data).

The image processing function 354 generates a CT image on the basis of CT image data. The image processing function 354 causes the display 342 to display the generated CT image.

The image processing function 354 can provide CT image in any desired format. For example, the CT image can be a set of voxels that with the value of each voxel representing X-ray attenuation at a corresponding position in three-dimensional space. The CT image can represent only photon intensity in some embodiments, and in some other embodiments the CT image can also include spectral information.

Although FIG. 1 illustrates a photon counting CT apparatus, any other suitable X-ray CT apparatus may be provided in alternative embodiments. For example, any suitable sequential X-ray CT or spiral X-ray CT or dual energy X-ray CT apparatus, or X-ray CT apparatus using energy-integrating detectors, may be provided in alternative embodiments.

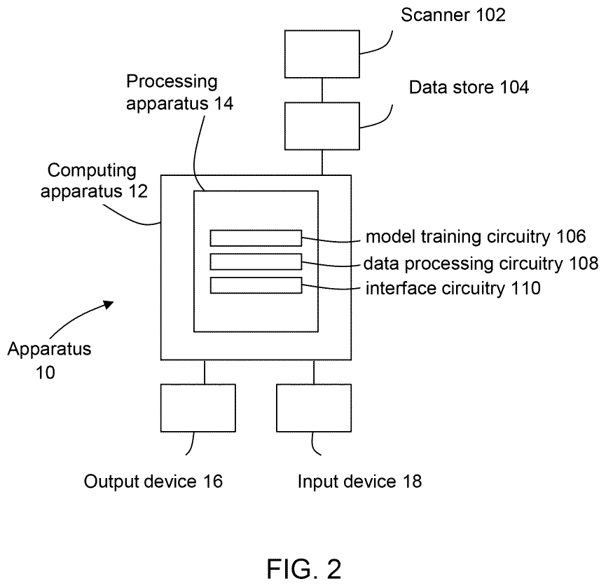

A data processing apparatus 10 according to an embodiment is illustrated schematically in FIG. 2. In the present embodiment, the data processing apparatus 10 is configured to process medical image data in the form of CT data received from X-ray CT apparatus 102 of FIG. 1 or from any other suitable X-ray CT apparatus in other embodiments. In other embodiments, the data processing apparatus 10 may be configured to process any other appropriate image data, for example medical image data according to other modalities and obtained from other types of scanners.

The data processing apparatus 10 forms part of X-ray CT apparatus 102 of FIG. 1 in some embodiments, for example forming part of console device 340, or may be provided as a separate apparatus in some embodiments with the data processing apparatus 10 and X-ray CT apparatus 102 together forming a combined X-ray CT apparatus.

The data processing apparatus 10 comprises a computing apparatus 12, which in this example is a personal computer (PC) or workstation. The computing apparatus 12 is connected to one or more output devices 16, such as a screen or other display device, and one or more input devices 18, such as a computer keyboard and mouse.

The computing apparatus 12 is configured to obtain data sets from a data store 104. At least some of the data obtained from the data store comprises medical imaging data, for instance X-ray CT data obtained using the scanner 102.

In alternative embodiments, the medical image data may comprise two-, three-or four-dimensional data in any imaging modality. For example, the scanner 102 may comprise a magnetic resonance (MR or MRI) scanner, CT (computed tomography) scanner, cone-beam CT scanner, X-ray scanner, ultrasound transducer, PET (positron emission tomography) scanner or SPECT (single photon emission computed tomography) scanner.

The computing apparatus 12 may receive data from one or more further data stores (not shown) instead of or in addition to data store 104. For example, the computing apparatus 12 may receive medical image data from one or more remote data stores (not shown) which may form part of a Picture Archiving and Communication System (PACS) or other information system.

Computing apparatus 12 provides a processing resource for automatically or semi-automatically processing the data. Computing apparatus 12 comprises a processing apparatus 14. The processing apparatus 14 comprises model training circuitry 106 configured to train one or more models, such as machine learning models. The processing apparatus 14 also comprises data processing circuitry 108 configured to apply trained model(s) and optionally to perform other processes for example image segmentation, image classification and/or automated reporting or any other suitable processes associated with viewing and analysing medical images. The processing apparatus 14 further comprises interface circuitry 110 configured to obtain user or other inputs and/or to output results of the data processing.

In the present embodiment, the circuitries 106, 108 and 110 are each implemented in computing apparatus 12 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 12 also includes a hard drive and other components of a PC including RAM, ROM, a data bus, an operating system including various device drivers, and hardware devices including a graphics card. Such components are not shown in FIG. 2 for clarity.

The data processing apparatus 10 of FIG. 2 is configured to perform methods as illustrated and/or described in the following.

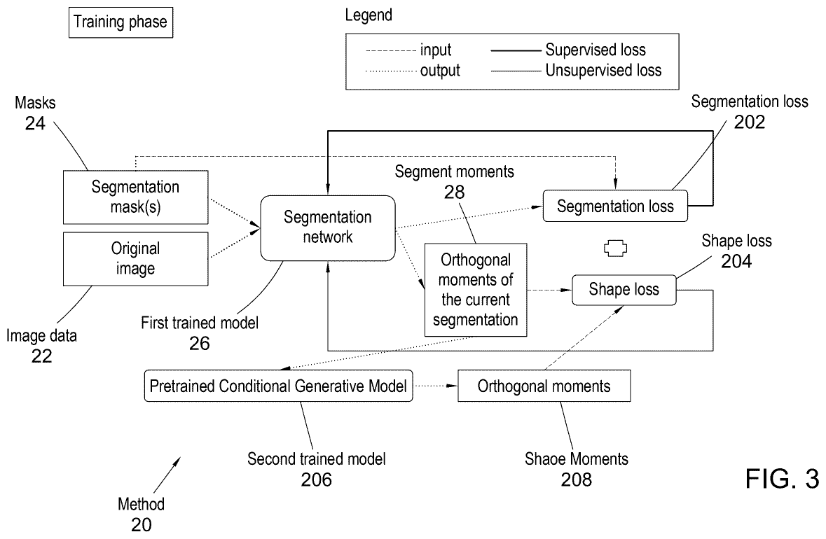

FIG. 3 is a schematic diagram illustrating a method of training a machine learning model to perform image segmentation, performed by the embodiment of FIG. 2.

At a first stage, input image data 22 is provided to a first machine learning model in the form of segmentation network 26. In the process of FIG. 3, the input image data represents at least one medical image comprising one or more anatomical features of interest.

In the embodiment of FIG. 2, the input image data comprises X-ray CT data obtained from the scanner 102 of FIG. 1.

In various embodiments, the input image data 22 may comprise one or more images in any imaging modality. The images may include semantic data. The images may comprise medical images. The image data 22 may be obtained from the data store 104, the scanner 102 or any other source of images.

At the first stage of the process, shape priors in the form of segmentation masks 24 are also provided to the first machine learning model in the form of segmentation network 26. The segmentation masks 24 segment a subset of the image data 22 to be processed. The segmentation masks 24 in this example identify and/or demarcate anatomical features of interest in the images.

Any other suitable methods may be used to specify the area or areas of the image data 22 to process during the training or use of the segmentation network 26 in alternative embodiments. The segmentation network 26 may be configured to perform segmentation on the input image data 22. The segmentation may identify and/or demarcate one or more anatomical features of interest in the input image data 22.

The first machine learning model in the form of segmentation network 26 comprises a neural network in the embodiment of FIG. 3. The segmentation network 26 may comprise a convolutional neural network (CNN), recurrent neural network (RNN) or any other appropriate neural network, in various embodiments. The segmentation network 26 may comprise a semantic or instance segmentation network. The segmentation network may perform mono-class segmentation or multi-class segmentation wherein only one of the classes is constrained, in various embodiments.

In one embodiment, the segmentation network 26 comprises a U-Net. U-Nets, characterized by their U-shaped architecture, were originally proposed for medical image segmentation but are also widely used for semantic segmentation. Composed of a contracting path and an expansive path, U-Nets are convolutional neural networks classically composed of four encoder blocks and four decoder blocks. Skip connections are used to preserve the spatial information lost during the reduction of the spatial information performed by the encoder. Any suitable U-Net architecture may be used.

The training process may, for example, be fully supervised or may be partially supervised. Partial supervision techniques do not possess the whole ground truth for the images before segmentation and may use shape prior(s) or bounding boxes or use few-slices-annotation or scribbles annotation or any other limited annotation, rather than full ground truth data in some embodiments.

The segmentation network 26 in its current state of training, for example with its current weights and/or other parameter values, generates a segmentation on the basis of the image data 22 and the segmentation masks 24. The segmentation that is output by the segmentation network may be referred to as a current segmentation. The current segmentation may contain one or more anatomical features of interest from the image data 22 on the basis of the segmentation masks 24.

As indicated schematically in FIG. 3, the current segmentation that is output by the segmentation network 26 is then used to calculate a current segmentation loss 202. The segmentation loss 202 is computed by the model training circuitry 106 on the basis of the current segmentation and a ground truth segmentation. The ground truth segmentation may be provided separately to the segmentation network 26. The segmentation loss represents a measure of difference between the current segmentation and the ground truth segmentation in this example. The ground truth segmentation in this example comprises a plurality of sets of image data obtained by prior scans on various patients in which segmentations of the anatomical or other feature of interest that is the subject of the present training process have been manually identified or verified by human expert(s).

Any suitable loss calculation process may be used to calculate the segmentation loss. For example, the training process may use a partial cross entropy loss, partial dice loss or any other suitable mechanism to compute the segmentation loss.

The segmentation loss in the example illustrated in FIG. 3 is based on a difference between the current segmentation and the ground-truth segmentation in respect of one or more anatomical features of interest.

It is a feature of various embodiments that the training of the first model 26 is based upon at least one loss that is based at least in part on the shape priors. In the embodiments of FIG. 3 the loss includes a shape loss as well as the segmentation loss. It is also a feature of various embodiments that differentiable and/or orthogonal moments are used to represent the shape priors.

The generation of moments 28 to represent the segmentations of the image data 22 output by the first model 26, i.e. the segmentation network in this embodiment, is indicated schematically in FIG. 3. The moments 28 comprise orthogonal moments of a current segmentation. The first model 26 may be trained to output the moments that represent the segmentations in some embodiments. However, in the embodiment of FIG. 3 the data processing circuitry 108 is configured to calculate in a separate process the segmentation moments 28 that can be used to represent the segmentations that are output by the first model 26.

The segmentation moments may comprise any differentiable moments used to represent the current segmentation(s). The segmentation moments 28 may be orthogonal moments used to represent the current segmentation performed by the segmentation network 26. The segmentation moments 28 may be one or more of Legendre moments, Chebyshev moments or Zernike moments.

As indicated in FIG. 3, the segmentation moments 28 are also provided to a second machine learning model in the form of pre-trained conditional generative model (CGN) 206. The CGN 206 may comprise a trained machine learning model. In this embodiment, the CGN 206 comprises a trained neural network.

The CGN 206 is trained to generate one or more shape priors based on one or more input shapes. The input shape(s) in this embodiment are defined by the segmentation moments 28. The CGN 206 of FIG. 3 is trained to output shape priors that represent anatomically plausible deformations or other variations of the shapes represented by the segmentations. Thus, in the process of FIG. 3 the shape priors represent anatomically plausible variations of the shapes of anatomical or other feature of interest as represented by the segmentations of the medical image data set.

The shape priors in the process of FIG. 3 are represented by differentiable and/or orthogonal moments. Thus, the output of the CGN is a set of differentiable moments referred to as shape moments 208 representing the set of shape priors, for example orthogonal moments. The shape moments may be any differentiable shape representation such as Legendre moments, Zernike moments and Chebyshev moments. Since the CGN 206 is exclusively trained on masks, it is agnostic to the modality of the image data 22.

As indicated schematically in FIG. 3, the segmentation moments 28 and the shape moments 208 are used to compute the shape loss 204. In the method of FIG. 3, the CGN 206 provides the shape moments 208 to the model training circuitry 106 and shape loss 204 is computed on the basis of the shape moments 208 and the segmentation moments 28. The shape loss 204 is computed as described in the following paragraph in the process of FIG. 3.

Let ‘λ-segment’ be a vector containing the successive Legendre moments of the current segmentation and ‘λ-shape’={λ1, . . . λN} the Legendre moments of the N shape variations generated by the trained CGN (206). The loss term ‘Lshape’ represented as shape loss 204 is computed as the weighted mean squared distance (or any suitable distance) between λ-mask and λ-shape.

Both computed losses (e.g. the segmentation loss 202 and the shape loss 204) are then provided to the first machine learning model in the form of segmentation network 26 as part of an iterative training process in which the losses are minimized or otherwise reduced to an acceptable level by gradually refining the weights or other parameters of the first machine learning model e.g. the segmentation network 26.

The losses may be weighted before being provided to the segmentation network. The neural network in the segmentation network is trained by the concurrent minimization of the segmentation loss and the shape loss. At each iteration of the process a segmentation of a better quality is presented.

The process continues iteratively in the manner described above until each loss is reduced to a predetermined level, or minimized, at which point the neural network in the segmentation network is considered trained to segment medical images that comprise anatomical features of interest similar to those comprising the current segmentation. As an example, the segmentation network may be trained to segment the heart in medical images, such as CT scan data, and once trained, the segmentation network may be able to segment the heart in previously unseen medical images.

The segmentation network may be hosted in the computing apparatus 12 or on the cloud or any other suitable storage medium. The model training circuitry 106 may instruct the computing apparatus 12 to initiate training of the segmentation network 26.

By combining an orthogonal moments-based loss and a generative network, suitable training of the model may be performed using a smaller number of annotations or partial annotations in the ground truth data. Furthermore, the shape priors can take into account local variations in imaging data through the use of differentiable moments. Expert annotation is often time consuming and hard to obtain. Including anatomical knowledge into the deep learning segmentation model may help to alleviate the annotation burden by allowing the use of less involved annotations such as partial slices annotations or scribbles.

Since the generative network generates fully realistic variations of the current segmentation, a discriminator is not needed in order to determine whether the segmented shape is real or not. The representation of shapes using moments also allows for the retrieval of fine details. Rather than using a general shape prior, a shape prior fully adapted to the current shape is used. The generative network may be used on one input shape or a plurality of input shapes while taking into account the shape information of neighbouring shapes.

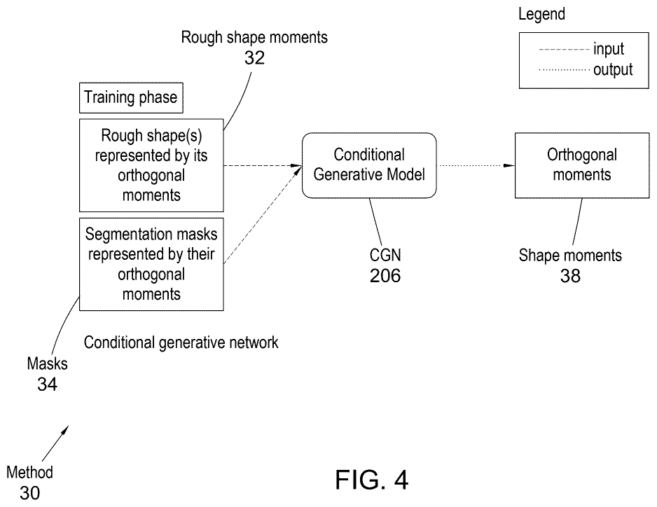

FIG. 4 is a schematic diagram illustrating a method 30 of training the conditional generative network 206 of FIG. 3 in certain embodiments. The CGN 206 is trained to generate one or more realistic variations of a shape given a representation of a shape as an input. The CGN may be trained using only binary masks. The CGN may be trained using medical images and/or image segmentations regardless of modality, for example CT or MRI data sets or data sets of any other suitable modality, obtained using a suitable scanner and representing anatomical features or regions of interest, optionally segmented using any suitable segmentation approach. Alternatively or additionally, the CGN may be trained using precise shape moments and/or masks. The CGN may be conditioned using rough shape moments that represent the shape currently being segmented. A suitable source of images for use in training in some embodiments includes any accurate segmentation of a tissue of interest or other anatomical feature of interest, regardless of modality. The input shape may be represented by differentiable moments, such as the segmentation moments 28 of FIG. 3.

In the training process for the CGN 206, rough shape moments 32 and masks 34 are provided to the CGN 206 in order to train it to generate models comprising variations of input shapes. These variations may be anatomically plausible deformations of the input shape. A large number of rough shape moments 32 and associated masks 34 may be provided to the CGN 206 during training in order to train it to generate anatomically plausible deformations of a subsequent shape input.

Training input images may be represented by differentiable moments, including orthogonal moments, such as Legendre moments or any differentiable shape representation. The trained CGN 206 generates one or more realistic and/or anatomically plausible variations by deforming the input data, wherein the input data is in the form of orthogonal moments representing segmentation moments 28.

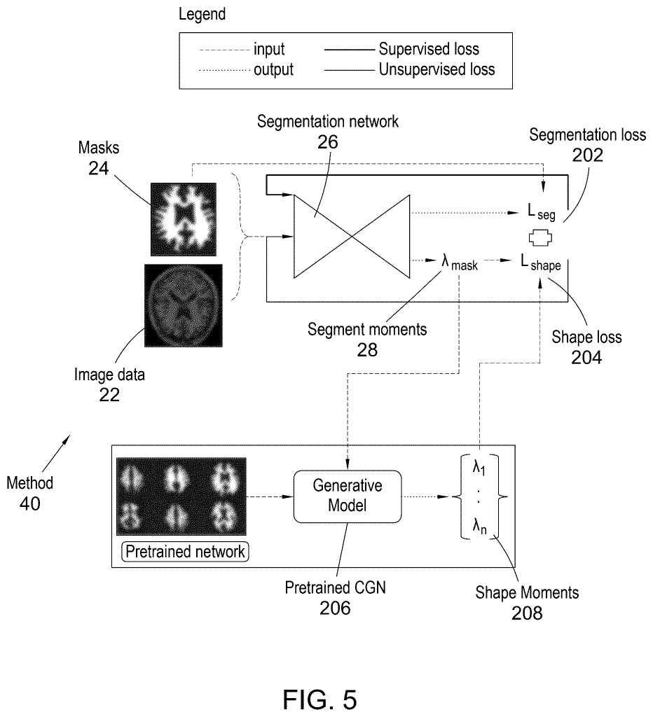

FIG. 5 is a schematic of a method 40 of segmenting images according to a further embodiment. Like reference numerals are used to represent like components in FIG. 3 and FIG. 5. FIG. 5 illustrates a training method for the segmentation network 26. The training of the network 26 comprises the use of a pre-trained conditional generative network 206. Image data 22 and one or more segmentation masks 24 are provided to the segmentation network. The segmentation network generates a segmentation and provides it to model training circuitry 106 (not shown in FIG. 5) which computes segmentation loss 202 on the basis of the current segmentation and the ground truth segmentation. The segmentation network 26 generates segmentation moments in the form of orthogonal moments and provides these to a shape loss mechanism 204. The segmentation moments 28 are further provided to a trained conditional generative model (CGN) 206.

The CGN 206 generates realistic and/or anatomically plausible variations of the shape represented by the segmentation moments 28 by deforming the shape and generates shape moments 208 describing each of the one or more variations generated. The shape moments 208 and segmentation moments 28 are then used by the model training circuitry 106 (not shown in FIG. 5) to compute shape loss 204. Each of these computed losses is fed back to the segmentation network 26. The losses may be weighted before being fed back to the segmentation network. The process continues in an iterative way until a predetermined level of loss is reached. The process results in a trained segmentation network. The images shown in FIG. 5 are X ray CT images obtained using the X-rat CT scanner 102.

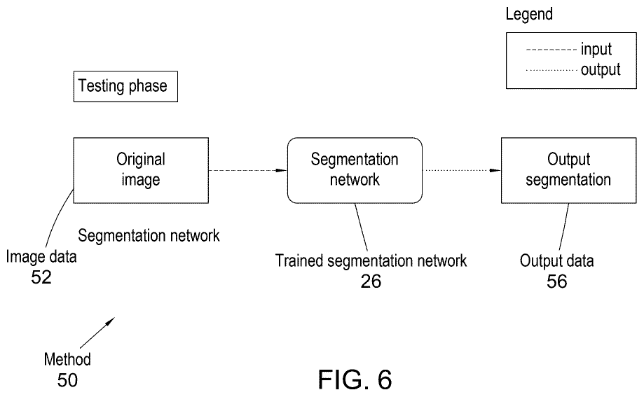

FIG. 6 is a schematic of a method 50 for using the trained machine learning model 26, once trained, for image segmentation. Image data 52 is provided to the segmentation network 26. The segmentation network 26 processes the image data 52 and generates an output segmentation 56.

In another embodiment that may be provided separately or as an extension to any of the methods described earlier, the effect of neighbouring objects may be incorporated into the training of the segmentation network. The deformation of one volume of tissue will result in a deformation of the surrounding tissue. The incorporation of this co-dependence in the trained image segmentation model can lead to better segmentation accuracy. Two examples are presented below for ways in which this can be implemented according to various embodiments.

Example 1: In the first example, it is assumed that at least some segmented shapes are conditioned or affected by their neighbours. Hence the shape of all segmented shapes depends on the deformation of their neighbouring shapes. In this example, shapes of all the tissues of interest are provided as input to the conditional generative network (e.g. CGN 206) or other trained model. The losses of the generative network may also be adapted or changed accordingly. These shapes may be provided in a differentiable moment representation. The set of shapes generated by the generative network, which may also be represented by differentiable moments, are hence conditioned by all shapes provided as inputs. The process can be elaborated using the segmentation of an image of the brain as an example. To generate a set of shapes to condition brain segmentation we may provide current segmentations of ventricles, white matter, grey matter and cerebrospinal fluid as inputs to the conditional generative network. The current segmentations may be in the form of differentiable moments. The ventricle output segmented shape, for example, will be conditioned by both the ventricle shape input but also all the other input shapes. The shape of the neighbouring tissues will limit the degrees of freedom that the generative model has in producing a shape model for the ventricle. The co-dependence can be weighted so that certain shapes have more or less impact on the shape of their neighbours. In the brain segmentation example, the deformation of grey matter will may have a lower impact on ventricle shape than deformation of the white matter and this can be reflected in weights assigned to some or each of the neighbouring shapes.

To be able to take into account the co-dependence of segment shapes on the shapes of their neighbours, the conditional generative network needs to be trained with specific losses and/or a different architecture to learn to handle multiple conditioning.

Example 2: In the second example only a subset of segmented shapes is provided to the generative network (e.g. CGN 206) or other trained model. The generative network outputs the shapes of all the other tissues conditioned solely by the ones provided as input. In the brain segmentation example, if only ventricles and white matter are provided as input, shapes of grey matter and cerebrospinal fluid would still be generated but conditioned only by the provided neighbouring tissues.

Both examples above are made possible by the inherent co-dependence between considered tissues and their neighbours that is dealt with using conditional generative networks.

This may be elaborated on with the following example. A generative network with no conditioning may be used to generate a brain image. However, in this case there is no control on the specific shapes of the substructures of the brain. What is need is a generative network that can be conditioned so that by it generates a brain image wherein the shape of generated structures depends on the conditioning information, such as shape priors for all the structures of the brain.

If only a subset of shape priors is provided, then only a subset of the generated structures are conditioned and the rest are generated with no explicit conditioning. However, for the ones generated with no explicit conditioning, they are still implicitly conditioned by the fact that neighbouring tissues may be conditioned and they are limited in the shapes that they can assume.

At least some embodiments may combine an orthogonal moments based loss and a generative network to obtain one or more of the following:
1) Learning using a smaller number of annotations or partial annotations.
2) Shape models or shape priors that take into account local variations in imaging data through the use of differentiable moments.
3) Segmentation that can be mono-class or multi-class and the ability to condition the generative network.
4) Improved fine-detail retrieval compared to computing losses based on overlap.

At least some embodiments may provide one or more of the following features:
1) Since the generative network generates fully realistic variations of the current segmentation, a discriminator is not needed in order to determine whether the segmented shape is real or not.
2) Multiple shapes may be conditioned at the same time.
3) The representation of shapes using moments allows for the retrieval of fine details.
4) Rather than using a general shape prior, a shape prior fully adapted to the current shape is used.
5) The generative network may be used on one input shape or a plurality of input shapes while taking into account the shape information of neighbouring shapes.

According to various embodiments, there is provided an X-ray CT apparatus for training machine learning model to segment medical images, the X-ray CT apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical feature of interest in the medical image data set by reducing at least one loss that is based at least in part on the shape priors.

According to various embodiments, there is provided a method for training a first machine learning model to segment medical image data, the method comprising:
providing a plurality of shape priors and a medical image data set to the first machine learning model, wherein the shape priors are based at least in part on a segmentation obtained from the medical image data set; and
training the first machine learning model to output a segmentation of an anatomical or other feature of interest in the medical image data set by reducing at least one loss that is based at least in part on the shape priors.

The at least one loss may comprise a segmentation loss based on the output segmentation, and a shape loss based at least in part on the shape priors. The shape priors may be generated by a second machine learning model, wherein the second machine learning model comprises a generative adversarial network (GAN) or other generative model. The second machine learning model may be pre-trained using binary masks as inputs.

The second machine learning model may receive an input representative of a mask corresponding to a shape of a current segmentation of the anatomical feature of interest output by the first machine learning model. The input may comprise differentiable and/or orthogonal moments representing the shape of the mask.

The shape priors may represent anatomically plausible variations of the anatomical or other feature of interest as represented in the medical image data set.

The at least one loss may be determined using differentiable and/or orthogonal moments representing the shape priors, and/or
the segmentation output by the first machine learning model during training may comprise differentiable and/or orthogonal moments representing a shape of the anatomical or other feature of interest. The orthogonal moments may comprise one or more of Legendre moments, Chebyshev moments or Zernike moments.

The segmentation loss may be determined using a ground-truth segmentation of the anatomical or other feature of interest. The shape loss may be based on a difference between the output segmentation and the shape priors.

The training of the first machine learning model may comprise an iterative training procedure that comprises iteratively outputting the segmentation and recalculating the at least one loss until the at least one loss is minimized or otherwise reduced to an acceptable level. The iterative training procedure may include re-generating the shape priors based on the current segmentation output by the first machine learning model.

The segmentation may comprise a plurality of segmentations, each segmentation corresponding to a respective different anatomical or other feature of interest. The shape priors may represent a plurality of different anatomical or other features of interest present in the medical image data set.

The at least one loss may be calculated based on the shape priors for all of said different anatomical or other features of interest. The shape priors for different anatomical or other features of interests may be given different weightings in calculation of the at least one loss.

The at least one loss may be calculated based on the shape priors for a selected one of said different anatomical or other features of interest. The shapes of the different anatomical or other features of interest may be dependent on one another, such that a change in shape determined for one of the anatomical or other features of interest may change a shape of one or more other of the anatomical or other features of interest.

The anatomical or other feature of interest may comprise one or more of an organ, a bone, a vessel, or a pathology, or part thereof.

According to various embodiments there is provided a method of segmenting a medical image data set, comprising
providing a medical image data set as an input to a first machine learning model trained used as claimed or described herein, and
obtaining a segmentation of an anatomical or other feature of interest in the medical image data set as an output of the first machine learning model.

According to various embodiments there is provided an apparatus for training machine learning model to segment medical images, the apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical or other feature of interest in the medical image data set by reducing at least one loss that is based at least in part on the shape priors.

In some embodiments, a method for conditioning machine learning models is provided which comprises neural networks using shape priors. One or more shape priors may be used to help guide a segmentation network towards an anatomically plausible solution. However, patients'individual anatomy, motion, acquisition angle, pathologies such as tumours etc. can lead the actual shape of an anatomical feature to differ significantly from any pre-computed shape prior. This variability may be taken into account and dynamic anatomically plausible and patient specific shape priors may be created to ensure better segmentation performance. Orthogonal moments may be used to constrain loss during supervised learning for a machine learning model or neural network. The use of orthogonal moments also takes into account local variations by retrieving fine details of the image data, such as anatomic variations between human subjects, and leads to a representation that is specific to the patient. For multi-label segmentation tasks, such as brain anatomical segmentation, the deformation of one tissue results in the deformation of the surrounding tissues. This co-dependence may be explicitly modelled and taken it into account in the deep network model leading to better accuracy of the segmentation model.

In some embodiments, a segmentation network may be conditioned using a shape prior derived from a multi-label shape generator and represented using orthogonal moments. The shape prior may be modality independent hence providing a way of conditioning neural networks to obtain better segmentation models without the need for additional data.

In some embodiments there is provided a medical imaging method that comprises and/or uses one or more of:
a) one of more images to be segmented; b) a segmentation method; c) a generative method; d) a set of binary images to be used for training the generative method; e) an unsupervised loss based on orthogonal moments; f) training the method mentioned in (b) using both a supervised loss and the unsupervised loss mentioned in (e); g) orthogonal moments computed as output of the segmentation method mentioned in (b) during training; h) training the method mentioned in (c) conditioned using moments representing a set of shapes and using the images mentioned in (d) to generate a set of shape priors in the form of orthogonal moments; i) generating a set of orthogonal moments representing shape priors using the method mentioned in (c) conditioned using the moments mentioned in (g) during the segmentation method's mentioned in (b) training; j) using the shape priors mentioned in (i) and the moments mentioned in (g) to compute the unsupervised loss mentioned in (e).
The representation of the shapes mentioned in (e) and (g) may be any suitable type of differentiable shape representation. The losses mentioned in (e) and (f) may be combined using any weighted or non-weighted scheme. The segmentation method in (b) may for example be any deep learning based single label segmentation method. The segmentation method in (b) may for example be any deep learning based multi-label segmentation method. The generation method in (c) may be any suitable conditional generative method. The generation method in (c) may be conditioned by one or multiple priors. The importance of the multiple priors used by the generation method may be weighted. The generation method in (c) may be conditioned by a subset of shape priors.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. An X-ray CT apparatus for training machine learning model to segment medical images, the X-ray CT apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical feature of interest in the medical image data set by reducing at least one loss that is based at least in part on the shape priors.

2. A medical image segmentation method for training a first machine learning model to segment medical image data, the method comprising:
providing a plurality of shape priors and a medical image data set to the first machine learning model, wherein the shape priors are based at least in part on a segmentation obtained from the medical image data set; and
training the first machine learning model to output a segmentation of an anatomical feature of interest in the medical image data set by reducing at least one loss that is based at least in part on the shape priors.

3. The medical image segmentation method according to claim 2, wherein the at least one loss comprises a segmentation loss based on the output segmentation, and a shape loss based at least in part on the shape priors.

4. A medical image segmentation method according to claim 2, wherein the shape priors are generated by a second machine learning model, wherein the second machine learning model comprises a generative adversarial network (GAN) or generative model.

5. A medical image segmentation method according to claim 4, wherein the second machine learning model is pre-trained using binary masks as inputs.

6. A medical image segmentation method according to claim 4, wherein the second machine learning model receives an input representative of a mask corresponding to a shape of a current segmentation of the anatomical feature of interest output by the first machine learning model.

7. A medical image segmentation method according to claim 6, wherein the input comprises differentiable and/or orthogonal moments representing the shape of the mask.

8. The medical image segmentation method according to claim 2, wherein the shape priors represent anatomically plausible variations of the anatomical feature of interest as represented in the medical image data set.

9. The medical image segmentation method according to claim 2,
wherein the at least one loss is determined using differentiable and/or orthogonal moments representing the shape priors, and/or
wherein the segmentation output by the first machine learning model during training comprises differentiable and/or orthogonal moments representing a shape of the anatomical feature of interest.

10. The medical image segmentation method according to claim 3, wherein the segmentation loss is determined using a ground-truth segmentation of the anatomical feature of interest.

11. The medical image segmentation method according to claim 3, wherein the shape loss is based on a difference between the output segmentation and the shape priors.

12. The medical image segmentation method according to claim 2, wherein the training of the first machine learning model is an iterative training procedure that comprises iteratively outputting the segmentation and recalculating the at least one loss until the at least one loss is minimized or otherwise reduced to an acceptable level.

13. The medical image segmentation method according to claim 2, wherein the segmentation comprises a plurality of segmentations, each segmentation corresponding to a respective different anatomical feature of interest.

14. The medical image segmentation method according to claim 2, wherein the shape priors represent a plurality of different anatomical features of interest present in the medical image data set.

15. The medical image segmentation method according to claim 2, wherein the anatomical feature of interest comprises one or more of an organ, a bone, a vessel, or a pathology, or part thereof.

16. The medical image segmentation method according to claim 2, further comprising:
providing a medical image data set as an input to the trained first machine learning model, and
obtaining a segmentation of an anatomical feature of interest in the medical image data set as an output of the trained first machine learning model.

17. A medical image segmentation apparatus for training a machine learning model to segment medical images, the medical image segmentation apparatus comprising processing circuitry configured to:
provide a plurality of shape priors and a medical image data set to a first machine learning model, wherein the shape priors are based at least in part on a segmentation obtained from the medical image data set; and
train the first machine learning model to output a segmentation of an anatomical feature of interest in the medical image data set by reducing at least one loss that is based at least in part on the shape priors.
